(19) United States
(12) Patent Application Publication
(10) Pub. No.: US 2016/0105938 A1
(43) Pub. Date: Apr. 14, 2016

(54) LED Lamp

(71) Applicant: Wanjiong Lin, Ningbo (CN)

(72) Inventors: Xiaolong Yu, Ningbo (CN); Jianguo Dong, Ningbo (CN); Jianfeng Yu, Ningbo (CN)

(73) Assignees: Self Electronics Co., Ltd., Ningbo (CN); Self Electronics USA Corporation, Norcross, GA (US); Wanjiong Lin

(21) Appl. No.: 14/883,297

(22) Filed: Oct. 14, 2015

(30) Foreign Application Priority Data
Oct. 14, 2014 (CN) 201410539704.6

(51) Int. Cl. H05B 33/08

(52) U.S. Cl. CPC H05B 33/0818; H05B 33/089; H05B 33/0845

(57) ABSTRACT

A LED lamp includes a body, and a switcher configured for controlling the body. The body includes two power input ends, a controlling signal input end, at least an LED load, and a controlling switch unit. The controlling switch unit controls the LED load to work according to an input signal from the controlling signal input end. The switcher includes a controlling signal output end. The controlling signal output end is electrically connected to the controlling signal input end and outputs controlling signal for the controlling switch unit to control working condition of the LED load. The switcher can be assembled onto any location of the LED lamp, such as two ends of the body, the junction assembly, and so on. As a result, it is easy for people to install, use and control the LED lamp.

### RELATED APPLICATION

The present application claims benefit of the Chinese Application, CN201410539704.6, filed on Oct. 14, 2014.

### BACKGROUND

1. Technical Field

The disclosure relates to lighting devices, and more particularly to a LED lamp.

2. Description of the Related Art

Lamps are a very common device in our daily life, such as roadside lamp, factory lighting, and household lighting device. Owing to different locations and purposes, lamps are used in different kinds of occasions, such as outdoor illumination and in high humidity environments, especially in a freezer, or a refrigerated cabinet, and so on. Moreover, LED lamp has large luminous flux and can be designed into more ingenuous structure and smaller volume. In use, people have a desire to easily install, use and control a plurality of LED lamps.

The above information disclosed in this section is only for enhancement of understanding of the background of the invention and therefore it may contain information that does not form the prior art that is already known in this country to a person of ordinary skill in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout three views.

FIG. 1 is a circuit diagram of the body of a LED lamp in accordance with one embodiment of the disclosure.

FIG. 2 is a circuit diagram of a switcher which is configured for controlling the body of FIG. 1.

FIG. 3A-3D discloses various connection of the LED lamp of FIG. 1.

### DETAILED DESCRIPTION

The disclosure is illustrated by way of example and not by way of limitation in the figures of the accompanying drawings. It should be noted that references to “an” or “one” embodiment in this disclosure are not necessarily to the same embodiment, and such references mean at least one.

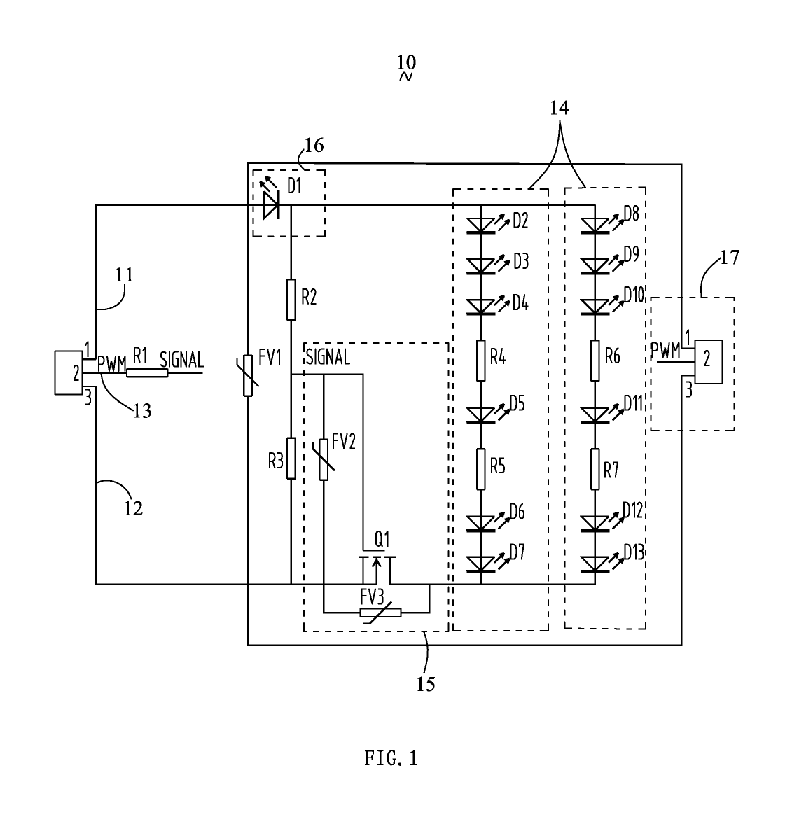

Referring to FIG. 1, a circuit diagram of a LED lamp 100 is shown. The LED lamp 100 includes at least one body 10, and a switcher 20 configured for controlling the body 10. Understandably, when the LED lamp 100 includes a plurality of the bodies 10 and the plurality of the bodies 10 cannot be interconnected in plug-in type in certain occasion, the LED lamp 100 may includes a junction assembly 30 for electrically connect many bodies 10.

The body 10 includes two power input ends 11, 12, a controlling signal input end 13, at least an LED load 14 electrically connected between the two power input ends 11, 12 in series, and a controlling switch unit 15 electrically connected between the controlling signal input end 13 and one of the two power input ends 11, 12 which has a lower level. As known for a person skilled in the art, the body 10 further includes other function components, such as PCB, wires, and so on, which need not to be described in detail.

The two power input ends 11, 12 are adopted for supplying power for the LED load 14 and are electrically connected to the LED load 14 via wires. One of the two power input ends 11, 12 is higher level and another is lower lever after flowing over the LED load 14. In the present embodiment, the power input end 11 is higher level, and the power input end 12 is lower level.

The controlling signal input end 13 is configured for inputting lamp controlling signal into the LED lamp 100 so as to controlling the parameter of the LED lamp 100, such as on/off, luminance, and so on.

The LED load 14 may include at least one LED chip which is electrically connected between the two power input ends 11, 12. The LED chip is a semiconductor light source and transforms power into light. The LED chip presents many advantages over traditional light sources including lower energy consumption, longer lifetime, improved physical robustness, smaller size, and faster switching. The anode of the LED load 14 is electrically connected to the higher level end, namely the power input end 11. The cathode of the LED load 14 is electrically connected to the lower level end, namely the power input end 12. The LED load 14 may include multiple units, and each unit may include a plurality of LED chips. The multiple units may be electrically connected to each other in parallel. In each unit, the plurality of LED chips are electrically connected to each other in series.

The body 10 further includes a reverse connection protection unit 16. The reverse connection protection unit 16 is configured to prevent the anode and the cathode of a power from reversing. That is to say, if the anode of the power is connected to the power input end 12 and the cathode is connected to the power input end 11, the LED load 14 may be burned. In the present embodiment, the reverse connection protection unit 16 is a diode. The anode and cathode of the diode has same connections type with that of the LED load 14 so as to avoid the LED load 14 from burning.

The controlling switch unit 15 controls the LED load 14 to work according to an input signal from the controlling signal input end 13. That is to say, the controlling switch unit 15 can control the work condition of the LED load 14, such as on/off, luminance, and so on. The input signal may be a PWM signal which has a certain duty cycle. Due to control principles, only the controlling switch unit 15 must be electrically connected with the lower level end, the PWM signal can be uploaded onto the voltage or current signal. The controlling switch unit 15 may be a MOS or a controlling module made of a triode and other function elements. In the present embodiment, the controlling switch unit 15 is a MOS (Metal Oxide Semiconductor). A grid electrode of the MOS is electrically connected to the controlling signal input end 13. A source electrode of the MOS is electrically connected to one of the two power input ends 11, 12. A drain electrode of the MOS is electrically connected to the cathode of the LED load 14. When the grid electrode of the MOS is higher level, the MOS will be breakover, and the body 10 will be turned on. And, the LED load 14 begins to glow. When the grid electrode of the MOS is lower level, the body will be turned off. Since the input signal of the controlling signal input end 13 is PWM signal which has a certain duty cycle and is not constant value, the output power is a percentage of the rated power. Therefore, the luminance of the LED load 14 can be adjusted. The controlling switcher unit 15 further includes two protection resistors FV2, FV3. The two protection resistors FV2, FV3 may be piezoresistors. Moreover, in order to prevent noise from flowing into the controlling switch unit 15, the body 10 further includes an isolation resistance R1. In the present embodiment, the isolation resistance R1 can prevent noise from flowing into the MOS.

When the controlling switch unit 15 includes the MOS, the body 10 further includes two resistors R2, R3 which are electrically connected between the two power input ends 11, 12 in series. The controlling signal input end 13 is electrically connected between the two resistors R2, R3. As the two resistors R2, R3 are used, the grid electrode of the MOS can be kept in higher level and the body 10 is turned on even if the controlling signal input end 13 has no inputting signal. Therefore, even if the LED lamp 100 has no controlling switch unit 15, the body 10 can be turned on as before. However, when the controlling signal input end 13 inputs the PWM signal, the level of the grid electrode of the MOS is changed as the PWM signal changes. The parameter of the LED lamp 100, such as on/off, luminance, and so on, can be controlled and adjusted.

The body 10 further includes an interconnected output end 17. The interconnected output end 17 is electrically connected to the two power input end 11, 12 so as to assemble to each other. Therefore, a plurality of bodies 10 can be interconnected to each other via the interconnected output end 17 according to practical demands so that the LED lamp 100 can increase length and illumination zone thereof. The interconnected output end 17 includes three output ends, namely two power output ends, and one controlling signal output end. The two power output ends are electrically connected with the two power input ends 11, 12. The controlling signal output end is electrically connected with the controlling signal input end 13.

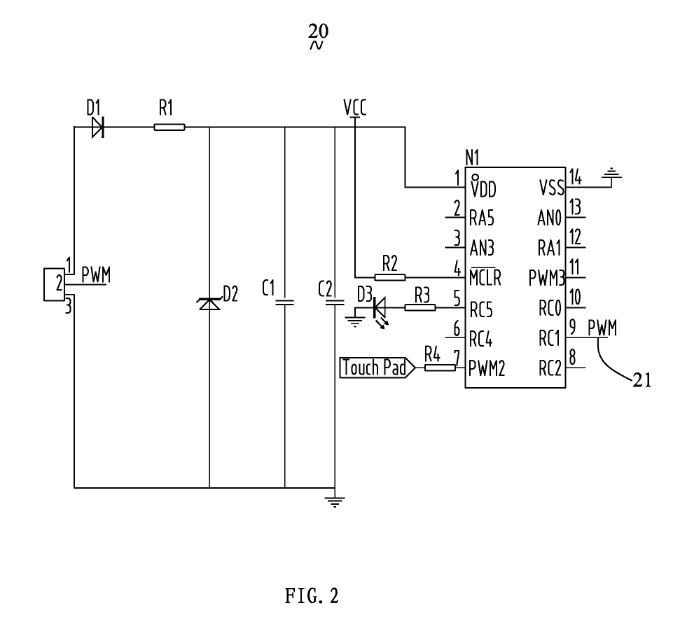

As shown in FIG. 2, a circuit diagram of the switcher 20 of the LED lamp 100 is presented. The switcher 20 includes a switch signal output end 21. The switch signal output end 21 is electrically connected to the controlling signal input end 13 so at to control the control condition of the LED load 14. The switcher 20 can be assembled onto the body 10 or the junction assembly 30. The switcher 20 may be a touch switcher, an infrared switcher, or a wireless switcher. In the present embodiment, the switcher 20 is the touch switcher.

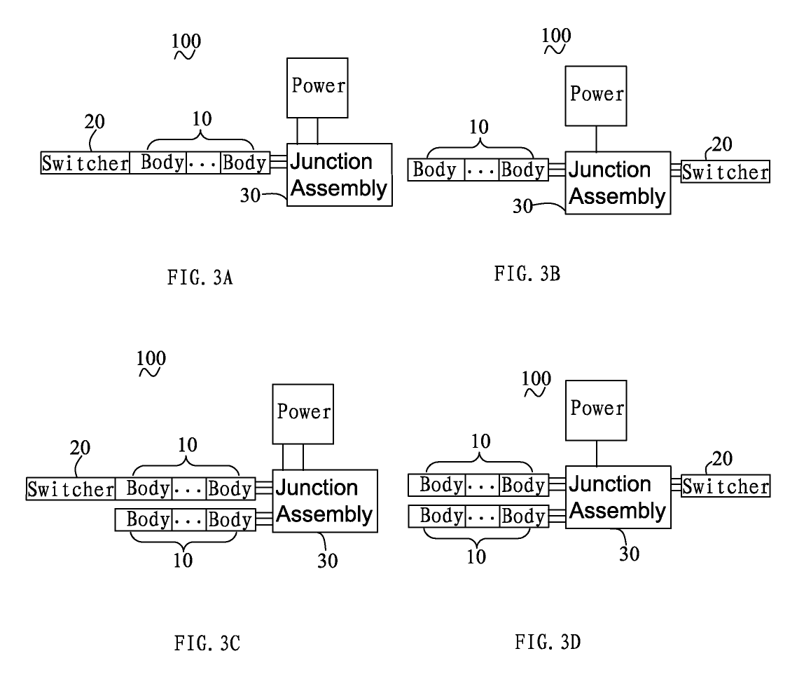

As presented in FIG. 3A-FIG. 3D, the junction assembly 30 is configured for electrically assembling more LED lamps to the body 10. When a plurality of bodies 10 or more than one interconnected bodies 10 cannot be electrically interconnected together, the junction assembly 30 may be used in this case and is well known for a person skilled in the art. However, the junction assembly 30 must include some function modules which are configured for electrically connected to the controlling signal input end 13 of the body 10 or the switch signal output end 21 of the switcher 20.

Referring to FIG. 3A-FIG. 3D again, in use, the switcher 20 can be assembled onto one of two ends of the body 10 as shown in FIG. 3A and FIG. 3C. The switcher 20 can be also assembled onto the junction assembly 30 as shown in FIG. 3B and FIG. 3D, and even electrically connected with the body 10 via wires.

Since the body 10 has the controlling signal input end 13 and the controlling switch unit 15, the parameter of the LED lamp 100 can be controlled as long as the switch signal output end 21 is electrically connected to the controlling signal input end 13. Therefore, the switcher 20 can be assembled onto any location of the LED lamp 100, such as two ends of the body 10, the junction assembly 30, and so on. As a result, it is easy for people to install, use and control the LED lamp 100.

While the disclosure has been described by way of example and in terms of exemplary embodiment, it is to be understood that the disclosure is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A LED lamp comprising a body, and a switcher configured for controlling the body, the body comprising two power input ends, a controlling signal input end, at least an LED load electrically connected between the two power input ends in series, and a controlling switch unit electrically connected between the controlling signal input end and one of the two power input ends which has a lower level, the controlling switch unit controlling the LED load to work according to an input signal from the controlling signal input end, the switcher comprising a controlling signal output end, the controlling signal output end electrically connected to the controlling signal input end and outputting controlling signal for the controlling switch unit to control working condition of the LED load.

2. The LED lamp of claim 1, wherein the body further comprises a reverse connection protection unit, the reverse connection protection unit is configured for avoiding an anode and cathode of a power from reversing.

3. The LED lamp of claim 1, wherein the controlling switch unit comprises a MOS (Metal Oxide Semiconductor), a grid electrode of the MOS is electrically connected to the controlling signal input end, a source electrode of the MOS is electrically connected to one of the two power input ends, and a drain electrode of the MOS is electrically connected to the cathode of the LED load.

4. The LED lamp of claim 3, wherein the body further comprises two resistors, the two resistors are connected in series each other and are electrically connected between the two power input ends, the controlling signal input end is electrically connected between the two resistors.

5. The LED lamp of claim 3, wherein the body further comprises an isolation resistance, the isolation resistance is electrically connected between the controlling signal input end and the controlling switch unit, the isolation resistance is configured for preventing noise from flowing into the controlling switch unit.

6. The LED lamp of claim 3, wherein the controlling switch unit further comprises two protection resistors, one of the two protection resistors is electrically connected between the grid electrode and the source electrode, another is electrically connected between the drain electrode and the source electrode.

7. The LED lamp of claim 6, wherein the protection resistors are piezoresistors.

8. The LED lamp of claim 1, wherein the body further comprises an interconnected output end, the interconnected output end is electrically connected to the two power input end so as to assemble the other.

9. The LED lamp of claim 1, wherein the LED lamp further comprises a junction assembly, the junction assembly is configured for electrically assembling more LED lamps to the body.

10. The LED lamp of claim 9, wherein the switcher is electrically connected to the body or the junction assembly to control working condition of the entire LED lamps.
